(19) United States
(12) Patent Application Publication
(10) Pub. No.: US 2008/0102231 A1
(43) Pub. Date: May 1, 2008

(54) Heat-Resistant Sheet

(75) Inventors: Katsuhiko Adachi, Osaka (JP); Osamu Saito, Osaka (JP); Chiho Matsushita, Osaka (JP); Minoru Yamano, Osaka (JP)

Correspondence Address: POSZ LAW GROUP, PLC, 12040 SOUTH LAKES DRIVE, SUITE 101, RESTON, VA, 20191, US

(73) Assignee: SIGMAX LTD., Osaka-shi, Osaka (JP)

(21) Appl. No.: 11/791,957

(22) PCT Filed: Dec. 5, 2005
(86) PCT No.: PCT/JP05/22291

§ 371 Date: May 31, 2007

(30) Foreign Application Priority Data
Dec. 6, 2004 (JP) 2004-352462

(51) Int. Cl. B41M 5/40; G09F 3/00

(52) U.S. Cl. 428/32.68

(57) ABSTRACT

The present invention provides a heat-resistant sheet comprising:
(A) a hydrolyzable functional group-containing silicone resin and
(B) an inorganic compound containing water of crystallization
   and/or hydroxy group(s).

### TECHNICAL FIELD

The present invention relates to a heat-resistant sheet. BACKGROUND ART

FA (Factory Automation) and CIM (Computer Integrated Manufacturing) have been introduced into production sites for industrial products. For example, production methods are employed in which the processing histories of products to be processed are input into a central computer system that controls the whole production process, or in which the information on processing steps is output from the computer system and reflected in the processing.

In such methods, to identify the products to be processed, automatically recognizable patterns, such as bar codes, two-dimensional codes, etc., are attached to the products or containers for carrying the products, and the patterns are optically read to exchange various information between the computer and reader. Labels made of paper, plastics, or like materials are usually used to attach the patterns. However, since such labels are lost at high temperatures, heat-resistant labels are necessary in industrial product manufacturing processes that involve heat treatment.

Japanese Patent No. 2654735 discloses a heat-resistant label that can be used in industrial product manufacturing processes that involve heat treatment, the label being obtained by affixing a sheet comprising an inorganic powder and silicone resin to an object and baking the sheet. The sheet, however, has a problem in that the heat-resistant label formed therefrom has insufficient strength due to insufficient curing of the silicone resin. Further, an adhesive containing a low-melting-point frit may be used in the sheet to improve the adhesion to an object, and when a lead oxide glass frit is used as the low-melting-point frit, the sheet may discharge lead into the environment.

Sheets for heat-resistant labels are therefore required to be capable of forming labels with higher strength, and to be lead-free.

### DISCLOSURE OF THE INVENTION

### Problems to be Solved by the Invention

An object of the present invention is to provide a heat-resistant sheet that is capable of forming a heat-resistant label with excellent strength by being affixed to an object and then heated, the heat-resistant sheet being lead-free.

### Means for Solving the Problems

The present inventors conducted extensive research to develop a lead-free heat-resistant sheet that is capable of forming a heat-resistant label with high heat resistance, high chemical resistance, high durability, and excellent strength when it is baked on an object to form thereon a heat-resistant label having a pattern such as a bar code, two-dimensional code, etc.

As a result, the present inventors found that a sheet prepared by using a material comprising a hydrolyzable functional group-containing silicone resin and an inorganic compound containing water of crystallization and/or hydroxy group(s), is capable of forming a heat-resistant label with excellent strength, since the water of crystallization and/or hydroxy group(s) in the inorganic compound are dehydrated or decomposed by heat applied during baking, to release water into the sheet, and the released water causes hydrolysis and condensation of hydrolyzable functional groups in the silicone resin. The present inventors further conducted various research based on the above new findings, and accomplished the present invention.

The present invention provides the following heat-resistant sheets.

1. A heat-resistant sheet comprising:
(A) a hydrolyzable functional group-containing silicone resin and
(B) an inorganic compound containing water of crystallization
   and/or hydroxy group or groups.

2. A heat-resistant sheet according to item 1, wherein the proportion of inorganic compound (B) is 1 to 300 parts by weight per 100 parts by weight of silicone resin (A).

3. A heat-resistant sheet according to item 1, further comprising an inorganic powder.

4. A heat-resistant sheet according to item 3, wherein the inorganic powder is at least one member selected from the group consisting of inorganic pigments, ceramic powders, inorganic fibers, glass powders, and metal powders.

5. A heat-resistant sheet according to item 1, further comprising an organic resin.

6. A heat-resistant sheet according to item 5, wherein the organic resin contains, in the resin structure, a moiety derived from an acidic monomer.

7. A heat-resistant sheet according to item 1, which has an adhesive layer on one or both sides thereof.

8. A heat-resistant sheet according to item 1, which has a pattern formed of an ink on one or both sides thereof.

9. A heat-resistant sheet according to item 1, which is for a heat-resistant label.

### Heat-Resistant Sheet

The heat-resistant sheet of the present invention is a raw material sheet for forming a heat-resistant label, heat-resistant seal, or the like, by being affixed to any of various objects and then baked. The sheet is especially suitable for a heat-resistant label.

It is essential that the heat-resistant sheet of the present invention comprise (A) a hydrolyzable functional group-containing silicone resin and (B) an inorganic compound containing water of crystallization and/or hydroxy group(s).

### Hydrolyzable Functional Group-Containing Silicone Resin (A)

The silicone resin (A), together with the inorganic compound (B), forms the sheet. The silicone resin (A) functions to form a film with excellent strength, and to firmly adhere to an object, since water generated from the inorganic compound (B) during baking causes hydrolysis and condensation of hydrolyzable functional groups of the silicone resin.

Examples of silicone resin (A) include silicone resins that comprise polydimethylsiloxane, polyphenylmethylsiloxane, etc., and that have C₁₋₆ lower alkoxy groups, such as methoxy, ethoxy, propoxy, butoxy, etc., as hydrolyzable functional groups.

Other examples of silicone resin (A) include various modified silicone resins, such as alkyd-modified silicone resins, phenol-modified silicone resins, melamine-modified silicone resins, epoxy-modified silicone resins, polyester-modified silicone resins, acrylic-modified silicone resins, urethane-modified silicone resins, etc., that have hydrolyzable functional groups. Colloidal silica and the like are also usable.

### Inorganic Compound (B) Containing Water of Crystallization and/or Hydroxyl Group(s)

A compound that is dehydrated or decomposed by heat applied at the time of baking to thereby release water can be used as the inorganic compound (B) containing water of crystallization and/or hydroxy group(s). Specific examples of such compounds include calcium sulfate dihydrate, calcium sulfite dihydrate, bismuth hydroxide, nickel hydroxide, barium hydroxide, hydrous calcium silicate, calcium hydroxide, magnesium hydroxide, basic magnesium carbonate, attapulgite, kaolin, etc.

It is usually preferable that the inorganic compound (B) have a mean particle diameter of about 0.5 to about 20 μm.

The above examples of the inorganic compound (B) are dehydrated or decomposed and start to release water at the following temperatures: calcium sulfate dihydrate at about 130 to about 160° C.; calcium sulfite dihydrate at about 100° C.; bismuth hydroxide at about 100 to about 150° C.; nickel hydroxide at about 200° C.; barium hydroxide at about 410° C.; hydrous calcium silicate at about 650 to about 800° C.; calcium hydroxide at about 550° C.; magnesium hydroxide at about 350° C.; basic magnesium carbonate at about 400 to about 500° C.; attapulgite at about 700 to about 900° C.; and kaolin at about 600° C. Since different compounds release water at different temperatures, one or more compounds that are suitable for the temperature and other conditions of baking the heat-resistant sheet are arbitrarily selected and used. When hydrolysis is desired to be performed in multiple steps, a mixture of multiple inorganic compounds with different dehydration temperatures is particularly useful.

The inorganic compound (B) is used in a proportion that can release a sufficient amount of water to sufficiently hydrolyze the hydrolyzable functional groups of the silicone resin (A). It is usually preferable that the proportion of inorganic compound (B) be about 1 to about 300 parts by weight, more preferably about 10 to about 300 parts by weight, and even more preferably about 30 to about 150 parts by weight, per 100 parts by weight of silicone resin (A).

### Inorganic Powder

The sheet of the present invention may further comprise an inorganic powder, if necessary.

The inorganic powder has the following functions: forming, in combination with the silicone resin (A) and inorganic compound (B), a sheet; imparting white or other colors to the sheet; improving the heat resistance, strength, printability, and the like of the sheet; imparting functions, such as radio wave-absorbing properties, dielectric properties, electrical resistance, electrical conductivity, and magnetic properties, etc.; preventing cracking, which is likely to occur after baking; etc.

Any inorganic powder that is used in this type of application can be used. Examples of usable inorganic powders include inorganic pigments, ceramic powders, inorganic fibers, glass powders, metal powders, etc. Such inorganic powders can be used singly or in combination.

The proportion of inorganic powder can be suitably selected according to the handleability, strength, hiding power, etc., of the sheet. It is usually preferable that the proportion be about 0 to about 300 parts by weight, and more preferably about 30 to about 150 parts by weight, per 100 parts by weight of silicone resin (A).

Examples of inorganic pigments include white pigments, red pigments, blue pigments, black pigments, yellow pigments, green pigments, pink pigments, and like inorganic pigments. It is usually preferable that such inorganic pigments have a mean particle diameter of not more than about 100 μm, more preferably not more than about 50 μm, and even more preferably about 0.05 to about 20 μm.

Examples of white pigments include silica, titania, alumina, zinc white, zirconia, calcium oxide, mica, etc.

Examples of red pigments include pigments containing iron, copper, gold, chromium, selenium and/or like metallic elements, such as manganese oxide-alumina, chrome oxide-tin oxide, iron oxide, cadmium sulfide-selenium sulfide, etc.

Examples of blue pigments include pigments containing manganese, cobalt, copper, iron, and/or like metallic elements, such as cobalt oxide, zirconia-vanadium oxide, chromium oxide-divanadium pentoxide, etc.

Examples of black pigments include pigments containing iron, copper, manganese, chromium, cobalt, and/or like metallic elements, such as chromium oxide-cobalt oxide-iron oxide-manganese oxide, potassium chromate, potassium permanganate, etc.

Examples of yellow pigments include pigments containing vanadium, tin, zirconium, chromium,. titanium, antimony, and/or like metallic elements, such as composite oxides of zirconium-silicon-praseodymium, composite oxides of vanadium-tin, composite oxides of chromium-titanium-antimony, etc.

Examples of green pigments include pigments containing chromium, aluminium, cobalt, calcium, and/or like metallic elements, such as composite oxides of chromium oxide-cobalt-chromium, composite oxides of alumina-chromium, etc.

Examples of pink pigments include pigments containing iron, silicon, zirconium, aluminium, manganese, and/or like metallic elements, such as composite oxides of aluminium-manganese, composite oxides of iron-silicon-zirconium, etc.

Examples of ceramic powders include powders of aluminium nitride (AlN), barium titanate (BaTiO₃), ruthenium oxide (RuO₂), silicon carbide (SiC), iron oxide (Fe₂O₃), magnetite (Fe₃O₄), etc. It is usually preferable that such ceramic powders have a mean particle diameter of not more than about 100 μm, more preferably not more than about 50 μn, and even more preferably about 0.05 to about 20 μn.

Inorganic fibers are components to be added for improvement of sheet strength, prevention of cracking, etc. Examples of inorganic fibers include silicon carbide whiskers, silicon nitride whiskers, alumina whiskers, titanate whiskers, zinc oxide whiskers, magnesia whiskers, aluminium borate whiskers, etc.

Such inorganic fibers preferably have a mean fiber length of not more than about 200 pm, and more preferably about 1 to about 50 μm. The mean fiber length is preferably 3 times or more, and more preferably about 5 to about 60 times, the mean fiber diameter. When the mean fiber length is less than 3 times the mean fiber diameter, the fibers are not well entangled with each other, so that improvement of sheet strength and prevention of cracking cannot be expected.

Other usable examples of inorganic fibers include glass fibers or carbon fibers in which long fibers have been cut to suitable lengths; carbon nanotubes, which are extremely small fibers at the nanometer scale; etc.

Since glass powders are melted and solidified during baking of the sheet, the addition of glass powder makes it possible to form a stronger heat-resistant label. It is usually preferable that glass powders have a mean particle diameter of not more than about 100 pm, more preferably not more than about 50 μm, and even more preferably about 0.05 to about 20 μm. A suitable glass powder can be selected depending on the baking temperature for the sheet. For example, when the baking temperature is about 400 to about 500° C., a powder of phosphoric acid glass, bismuth glass, or the like can be used, and when the baking temperature is about 500 to about 800° C., a powder of borosilicate glass or the like can be used.

The addition of metal powder imparts electrical conductivity, light shielding properties, radio wave shielding properties, electrical resistance, and like properties to the resulting heat-resistant label. Metal powders are obtained by pulverizing metals, and are in the shape of fragments, spheres, blocks, granules, flakes, needles, scales, or the like, which can be selected according to the purpose. The mean particle diameter of metal powder is preferably about 0.01 μm to about 1.0 mm, and more preferably about 0.1 μm to about 500 μm. The kind of metal is not limited, but metals that are stable and do not oxidize when baked are preferable. Specific examples include zinc, nickel, aluminium, tin, iron, stainless steel, gold, silver, platinum, palladium, copper, metal silicon, titanium, alloys thereof, etc. A suitable kind of metal can be selected according to the desired properties, such as electrical conductivity.

### Organic Resin

The sheet of the present invention may contain an organic resin, if necessary. It is preferable that the organic resin be capable of imparting the optimum strength, flexibility, etc., when forming the sheet, and be sufficiently decomposed in the baking step so that no ash content remains. Further, it is preferable that the organic resin contain, in the resin structure, a moiety derived from an acidic monomer, because when the organic resin is decomposed in the baking step, acidic components in the organic resin promote the hydrolysis of the hydrolyzable functional groups of the silicone resin (A) to thereby improve sheet strength and firmly adhere the sheet to the object.

The proportion of organic resin can be suitably selected according to the strength, flexibility, etc., of the sheet. It is usually preferable that the proportion be about 5 to about 300 parts by weight, and more preferably about 10 to about 100 parts by weight, per 100 parts by weight of silicone resin (A).

Specific examples of organic resins include hydrocarbon resins, vinyl resins, styrene resins, acetal resins, butyral resins, acrylic resins, polyester resins, urethane resins, cellulose resins, etc. Organic binder resins, such as various waxes and the like, are also usable. In particular, when baking is carried out at a relatively low temperature, acrylic resins are suitable as organic resins. Acidic monomers that can be used as raw material monomers for the above-mentioned resins include acrylic acid, methacrylic acid, maleic acid, fumaric acid, etc.

### Sheet Production and Heat-Resistant Label Formation

The sheet of the present invention can be produced by, for example, a process in which a hydrolyzable functional group-containing silicone resin (A), inorganic compound (B), and, if necessary, optional components such as an inorganic powder, organic resin, etc., are dispersed in an organic solvent or the like using a ball mill or like apparatus to obtain a mixture, which is then spread and dried on a support such as a mold-releasing film or like separator. It is usually suitable that drying be performed at about 50 to about 110° C. for about 10 to about 60 minutes.

When preparing the mixture, additives such as dispersants, plasticizers, combustion improvers, etc., can be added as required. The solids content of the mixture is not limited, but is preferably about 5 to 85 wt. % from the viewpoint of excellent spreadability and other properties.

The above-mentioned organic solvent is not limited, but, for example, toluene, xylene, butyl carbitol, ethyl acetate, butyl cellosolve acetate, methyl ethyl ketone, methyl isobutyl ketone, etc., can usually be used.

The mixture is preferably spread by a method with excellent layer-thickness controllability, such as a doctor blade method, gravure roll coater method, or the like. It is usually preferable that the sheet formed have a dry thickness of about 1 μm to about 10 mm, and more preferably about 20 to about 200 μm. When the thickness is less than 1 μm, the sheet has poor strength, whereas if the thickness is more than 10 mm, the sheet is likely to be cracked when baked.

When the sheet of the present invention is used as a heat-resistant label for automatic recognition, arbitrary patterns used for automatic recognition, such as bar codes, two-dimensional codes, or the like, are printed or otherwise formed using a known ink, on one or both sides of the sheet. Patterns other than those that are automatically recognizable, such as characters, pictures, symbols, etc., may also be formed.

The attached drawings show representative examples of patterns to be formed. FIG. 1 shows examples of matrix-type two-dimensional codes. FIG. 2 shows examples of bar codes.

It is usually preferable that the ink be heat resistant. However, when the heat-resistant label is baked and used at a relatively low temperature (e.g., about 300° C.), a non-heat-resistant ink, such as carbon ink, can be used.

Coloring pigments for use in the heat-resistant ink are not limited, as long as they are excellent in heat resistance, corrosion resistance, durability, etc. and provide a clear contrast to the color of the baked label. When the label has a white or nearly white color, usable coloring pigments include oxides of a single metal such as Fe, Cr, Co, Mn, or the like, composite oxides of such metals, and the like.

The sheet of the present invention may be provided with an adhesive on one or both sides thereof, in order to temporarily fix the sheet on an object until the baking step.

The adhesive can be suitably selected in accordance with the baking temperature, material of the object, etc. Specific examples of adhesives include silicone adhesives, rubber adhesives, acrylic adhesives, vinyl acryl ether adhesives, epoxy adhesives, etc.

Silicone adhesives can be used within an ordinary baking temperature range. Silicone adhesives are especially useful for adhesion to objects with a rough surface, such as ceramic sheets.

Epoxy adhesives show excellent adhesion to concrete building materials and like objects.

When the baking temperature is 400° C. or higher, rubber adhesives or acrylic adhesives, which are decomposed and eliminated at a relatively low temperature of about 200 to about 300° C., are preferably usable. Examples of such adhesives include natural rubbers and their synthetic analogues, butyl rubbers, polyisobutylene rubbers, styrene-butadiene rubbers, styrene- isobutylene-styrene block copolymers, and like rubber polymers used singly; and mixtures obtained by mixing 100 parts by weight of polymers mainly including such a rubber polymer or alkyl (meth)acrylate polymer, with about 10 to 300 parts by weight of tackifier such as a petroleum resin, terpene resin, rosin resin, xylene resin, or the like, and if necessary, a softener, antioxidant, coloring agent, etc.

Such an adhesive is spread over a separator or like support by a method with excellent layer-thickness controllability, such as a doctor blade method, gravure roll coater method, or the like; dried; and then affixed to the sheet. It is usually preferable that the adhesive layer formed have a thickness of 1 μm to about 100 μm, and more preferably about 5 to about 20 μm. A thickness of less than 1 μm results in poor adhesion, whereas a thickness of more than 100 μm makes the ash content likely to remain.

The sheet of the present invention can be made into a heat-resistant label by being affixed to an object and then baked to bond the sheet firmly to the object. The baking is usually carried out at about 200 to about 800° C. for about 10 to about 60 minutes. The atmosphere for baking is not limited, and may be an oxidizing atmosphere, non-oxidizing atmosphere, or reducing atmosphere, and more specifically, may be an air atmosphere, nitrogen atmosphere, inert gas atmosphere, or the like.

The object to which the sheet is affixed is not limited to industrial products that require heat treatment or containers for such products. Various articles that require heat-resistant labels can be used as the object. It is especially preferable to use as the object an article made of glass, metal, ceramic, concrete, or the like.

### Effects of the Invention

The heat-resistant sheet of the present invention achieves the following remarkable effects.

(1) When the sheet of the present invention is affixed to any of various objects and then baked, a heat-resistant label can be formed which is excellent in heat resistance, chemical resistance, and durability, and which is lead-free. The formed heat-resistant label has such excellent heat resistance that the label can be suitably used at, for example, about 200 to about 800° C.

(2) The sheet of the present invention can therefore be used as directly affixed to products that need to be environmentally friendly, thereby contributing not only to the automation of production of various industrial products that involves heat treatment, but also to improvement of the global environment.

### BRIEF DESCRIPTION OF THE DRAWINGS

FIG. 1 shows examples of matrix-type two-dimensional codes.

FIG. 2 shows examples of bar codes.

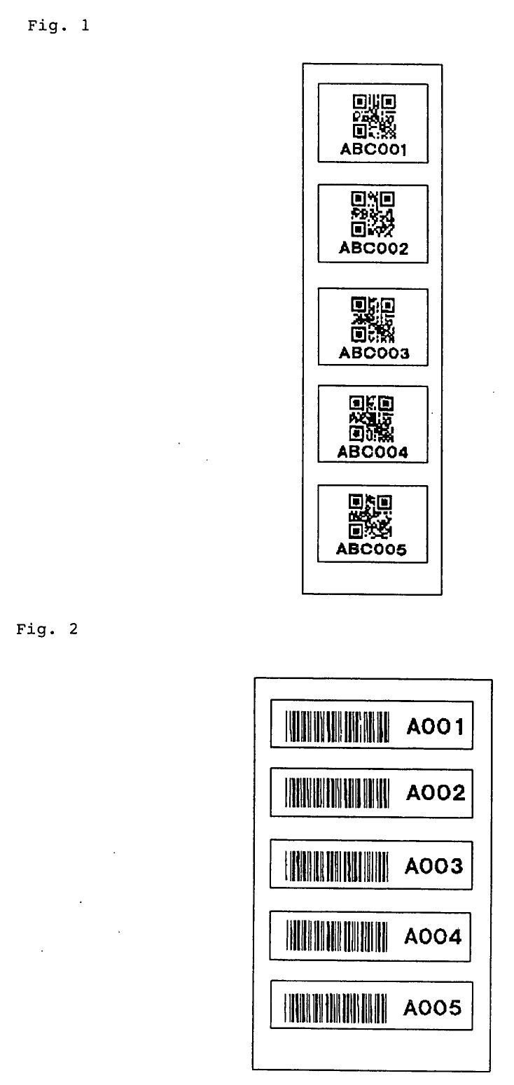

### BEST MODE FOR CARRYING OUT THE INVENTION

The following Examples are provided to illustrate the present invention in further detail.

### EXAMPLE 1

One hundred parts by weight of hydrolyzable functional group-containing silicone resin (tradename “KR-255”; product of Shin-Etsu Chemical Co., Ltd.; butoxy-containing methyl phenyl silicone resin; molecular weight: 3×10⁵), 50 parts by weight of titania with a mean particle diameter of 0.2 μm (tradename “A220”; product of Ishihara Sangyo Kaisha Ltd.), 30 parts by weight of magnesium hydroxide with a mean particle diameter of 10 μm, 20 parts by weight of acrylic resin containing in its resin structure a moiety derived from an acidic monomer (tradename “B66”; product of Rohm and Haas Co.; molecular weight: 7×10⁴) and 50 parts by weight of toluene were homogeneously mixed in a ball mill to obtain a paste. The paste was then applied over a mold-releasing film by a doctor blade method, dried at 75° C. for 30 minutes, and peeled off to obtain a 70 μm-thick sheet of the present invention.

Subsequently, an acrylic adhesive (tradename “BPS”; product of Toyo Ink Mfg. Co., Ltd.) was applied over a mold releasing film by a doctor blade method, and transferred to one side of the above-obtained sheet, to obtain a sheet with a 15 μm-thick adhesive layer. The sheet was affixed to a glass plate object, and baked in an air atmosphere at 450° C. for 30 minutes. Thus, a lead-free heat-resistant label was formed on the glass plate.

### EXAMPLE 2

One hundred parts by weight of hydrolyzable functional group-containing silicone resin (tradename “KR-255”; product of Shin-Etsu Chemical Co., Ltd.; butoxy-containing methyl phenyl silicone resin; molecular weight: 3×10⁵), 40 parts by weight of titania with a mean particle diameter of 0.2 μm (tradename “A220”; product of Ishihara Sangyo Kaisha Ltd.), 15 parts by weight of calcium sulfate dihydrate with a mean particle diameter of 10 μm, 15 parts by weight of magnesium hydroxide with a mean particle diameter of 10 μm, 30 parts by weight of acrylic resin containing in its resin structure a moiety derived from an acidic monomer (tradename “B66”; product of Rohm and Haas Co.; molecular weight: 7×10⁴), and 50 parts by weight of toluene were homogeneously mixed in a ball mill to obtain a paste. The paste was then applied over a mold-releasing film by a doctor blade method, dried at 75° C. for 30 minutes, and peeled off to obtain a 70 μm-thick sheet of the present invention.

Subsequently, an acrylic adhesive (tradename “BPS”; product of Toyo Ink Mfg. Co., Ltd.) was applied over a mold releasing film by a doctor blade method, and transferred to one side of the above-obtained sheet, to obtain a sheet with a 15 μm-thick adhesive layer. The sheet was affixed to a glass plate object, and baked in an air atmosphere at 450° C. for 30 minutes. Thus, a lead-free heat-resistant label was formed on the glass plate.

1. A heat-resistant sheet comprising:
(A) a hydrolyzable functional group-containing silicone resin and
(B) an inorganic compound containing water of crystallization and/or hydroxy group or groups and
an acrylic resin containing, in the resin structure, a moiety derived from an acidic monomer.

2. A heat-resistant sheet according to claim 1, wherein the proportion of inorganic compound (B) is 1 to 300 parts by weight per 100 parts by weight of silicone resin (A).

3. A heat-resistant sheet according to claim 1, further comprising an inorganic powder.

4. A heat-resistant sheet according to claim 3, wherein the inorganic powder is at least one member selected from the group consisting of inorganic pigments, ceramic powders, inorganic fibers, glass powders, and metal powders.

5-6. (canceled)

7. A heat-resistant sheet according to claim 1, which has an adhesive layer on one or both sides thereof.

8. A heat-resistant sheet according to claim 1, which has a pattern formed of an ink on one or both sides thereof.

9. A heat-resistant sheet according to claim 1, which is for a heat-resistant label.

10. A heat-resistant sheet according to claim 1, wherein the proportion of the acrylic resin containing, in the resin structure, a moiety derived from tan acidic monomer is 5 to 300 parts by weight per 100 parts by weight of silicone resin (A).
